(19) United States
(12) Patent Application Publication
(10) Pub. No.: US 2009/0073972 A1
(43) Pub. Date: Mar. 19, 2009

(54) ADDRESS MANAGEMENT METHOD AND MESSAGE TRANSMITTING AND RECEIVING METHOD IN NETWORK CONTROL SYSTEM

(75) Inventors: Koon Seok Lee, Kyungsang-namdo (KR); Sang Kyun Lee, Seoul (KR); Jong Hoon Chung, Gyeonggi-do (KR); Woong Jeon, Seoul (KR)

Correspondence Address: MCKENNA LONG & ALDRIDGE LLP, 1900 K STREET, NW, WASHINGTON, DC, 20006, US

(73) Assignee: LG ELECTRONICS, Seoul (KR)

(21) Appl. No.: 11/883,798

(22) PCT Filed: Feb. 7, 2006
(86) PCT No.: PCT/KR2006/000435

§ 371 Date: Sep. 26, 2008

(30) Foreign Application Priority Data
Feb. 7, 2005 (KR) 10-2005-0011144

(51) Int. Cl. H04L 12/56

(52) U.S. Cl. 370/389

(57) ABSTRACT

The present invention relates to an address management and message transmitting and receiving method in a network control system. The present invention, for example, enables a user in the inside or outside of house to control the operation or monitor the operation status of various appliances such as refrigerator, laundry machine, etc through a network such as RS-485 network, low power RF network, power line network, etc. installed at home, thus making it possible to provide the convenience of remote control and monitoring to the user. In addition, the present invention may flexibley assign and manage addresses for all the devices connected to one another through the network, and transmit and receive messages between a master and a slave, thus making it possible to control the appliances in the network control system more efficiently.

### 1. TECHNICAL FIELD

The present invention relates to an address management method and a message transmitting and receiving method in a living network control system for a user, for example, who is locating at home or out-of-home to effectively control household appliances such as refrigerator or laundry machine connected to a living network.

### 2. BACKGROUND ART

In general, ‘home network’ means a network in which various digital appliances are connected to one another for the user to enjoy economical home services in a convenient and safe way anytime at home or out-of-home, and due to the development of digital signal processing technology, various types of appliances such as refrigerator or laundry machine are being gradually digitalized.

On the other hand, in recent years, home network has been more advanced, since operating system and multi-media technology for appliances has been applied to digital appliances, as well as new types of information appliances have appeared.

Moreover, in a general meaning, a network which is established for providing file exchanges or internet services between personal computers and peripheral devices, a network between appliances for handling audio or video information, and a network established for home automation of various appliances such as refrigerator or laundry machine, appliance control such as remote meter reading, and the like are called a ‘living network’.

Furthermore, in the network services in which small-scale data transmission for the remote control, or operating state monitoring of the appliances included in the network, for example, various appliances such as refrigerator or laundry machine, is the main object of their communication, each of appliances connected to one another should be directly controlled by a network manager, which is included in the living network, with the use of the minimum required communication resources. However, its effective solution has not been provided yet, and thus it is a matter of urgency to provide its solution.

### 3. DISCLOSURE OF INVENTION

Accordingly, the present invention is designed in consideration of the aforementioned situation, and it is an object of the present invention to provide an address management method and a message transmitting and receiving method in the network control system enabling a user, for example, who is locating at home or out-of-home can effectively control various appliances such as refrigerator or laundry machine connected to a network by using the minimum required communication resources, and as well to assign and manage addresses for all the devices connected in the living network more flexibly.

In order to achieve the aforementioned object, an address management method in a living network control system according to the present invention assigns one address to a master and a slave in the living network control system, wherein the address field structure comprises an address option for classfying node address or cluster address; a fixed address fixed according to product kind; and a dynamic address for classifying a plurality of the same products, or classifying the cluster.

Further, a message transmitting and receiving method in a network control system according to the present invention comprises the steps of assigning an address comprising an address option for classfying node address or cluster address, a fixed address fixed according to product kind, and a dynamic address for classifying a plurality of appliances for the same product, or classifying the cluster; and performing message transmitting and receiving operation between the master and slave, based on the assigned address.

### 4. BRIEF DESCRIPTION OF DRAWINGS

FIG. 1 is a construction diagram of a network control system according to the present invention.

FIGS. 2 and 3 are block diagrams of illustrating a master-slave based communication structure applied to the present invention.

FIG. 4 is a block diagram of illustrating a layered structure of LnCP network applied to the present invention.

FIGS. 5 to 7 are block diagrams of illustrating embodiments for communication cycle service applied to the present invention.

FIG. 8 is a block diagram of illustrating an embodiment of address field structure according to the present invention.

### 5. MODES FOR CARRYING OUT THE INVENTION

Hereinafter, preferred embodiments for an address management method and a message transmitting and receiving method in a network control system according to the present invention will be described in more detail with reference to the accompanying drawings.

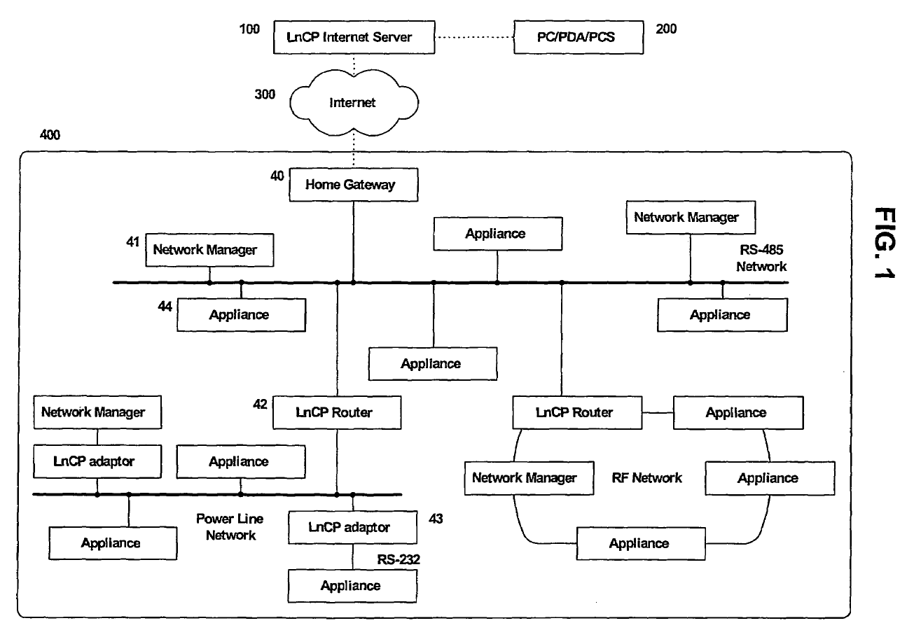

FIG. 1 is a construction diagram of a network control system according to the present invention. For example, a LnCP Internet server 100, to which a network control protocol newly defined by the present invention, for example, ‘a living network control protocol (LnCP)’, is applied, is connected through the Internet to a living network control system 400 as shown in FIG. 1, and the LnCP Internet server 100 performs interfacing with various communication terminals 200 including personal computer (PC), PDA, PCS, etc.

Meanwhile, the living network control system 400 comprises a home gateway 40, network managers 41, LnCP routers 42, LnCP adaptors 43, and appliances 44, in which a data link layer such as RS-485 network or low power RF network uses a non-standard transmission medium, or a data link layer such as power line communication or IEEE 802.11, ZigBee (IEEE 802.15.4) uses a standard transmission medium as shown in FIG. 1.

In addition, the living network control system 400 may also be called, for example, ‘LnCP network’, which is configured as an independent network connecting the appliances included in the living network region within an independent home with a wireless or wired medium.

Meanwhile, the LnCP network is connected to a master device, which can control the operation or monitor the operation status of other appliances, and a slave device, which has a capability of responding to the request from the master device and informing its information regarding the state variation.

And, the network manager is in charge of the environment set up and management of the appliances 44 connected to the LnCP network as shown in FIG. 1. The appliances 44 may be connected directly to the network or indirectly to the network via the LnCP adaptor 43. And, the RS-485 network, RF network, power line network and the like are connected to the LnCP network via the LnCP router 42.

In addition, the LnCP network provides a capability that an outdoor user may check or control the state of appliances installed in the home through the connection with the external Internet 300. For this, the home gateway 40 is in charge of the connection between LnCP network and the external Internet. Accordingly, if accessing the LnCP Internet server 100 from the exterior and passing an authentication procedure, the user may check or control the state of the appliances connected to the LnCP network from the exterior.

In addition, the user may access the LnCP Internet server 100 through the home gateway 40 in the appliances connected to the LnCP network, and then download contents provided by the LnCP Internet server. Principle properties of the LnCP network will be described below in more detail.

Digital information appliances include micro controllers having various performances, each being capable of performing unique functions, and the LnCP network according to the present invention enables the resources of the micro controller mounted in the appliance to be minimally used by simplifying the functions more efficiently to be capable of being operated in the micro controllers of the various performances. Especially, the LnCP network allows low performance micro controllers to process LnCP communication function while performing their unique functions, and high performance micro controllers to support the multi tasking.

And, the principal properties of the LnCP network according to the present invention may be classified into master-slayer based communication structure, event driven communication support, multiple network manager support, 4 layered structure, communication cycle service, flexible address management, variable-length packet communication, and standard message set provision.

Meanwhile, the master-slave based structure, which is used as a connection communication structure between appliances in the LnCP network, should include at least one and more master devices, which should include the information and control code for the slave devices which the master devices will control. At this time, the master device follows the inputted program or receives the input from user and then controls the other slave devices.

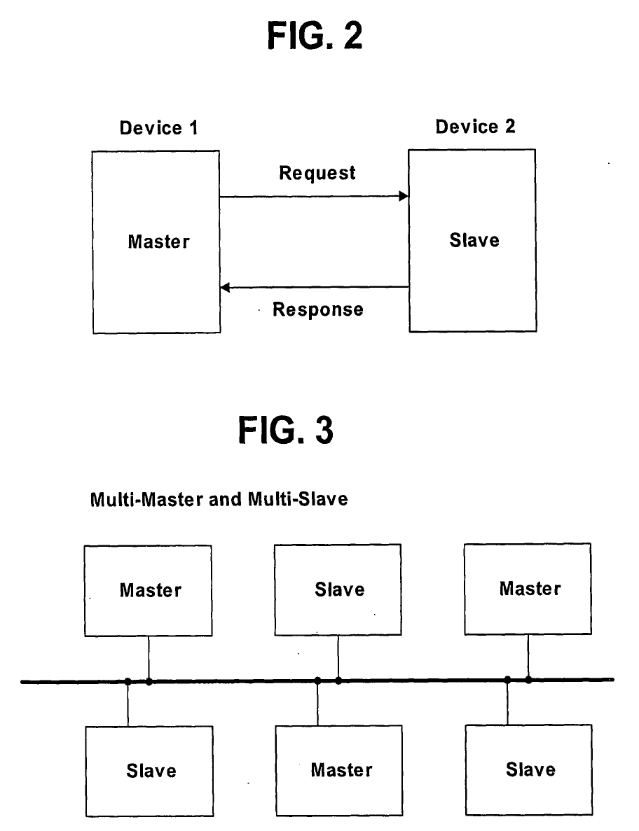

For example, the message flow between the master device and the slave device is as shown in FIG. 2. That is, if the master device sends request message to the slave device, then the slave device sends back response message to the master device. The LnCP network may also have multi-master and multi-slave based communication structure as shown in FIG. 3.

And, the LnCP network supports the event-driven communication service. For example, the user may set up an event needed for appliances. Thereafter, if the event occurs which the user set up during performing any operations, the corresponding appliance informs other appliances of the event occurrence or the description of the event, or controls the operation status of the other appliances corresponding to the event.

In addition, the LnCP network, which comprises at least one and more network managers in charge of environment set up and management, may support a number of network managers if needed. In this case, the management information of appliances should be synchronized for error of the network managers.

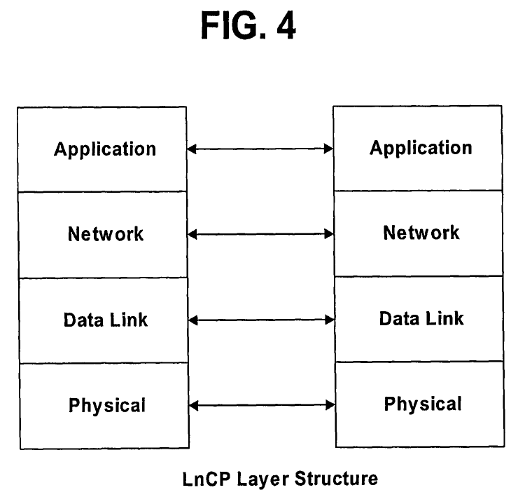

And, the LnCP network has 4 layered structure including physical layer, data link layer, network layer, and application layer, as shown in FIG. 4, and provides services in the unit of communication cycle, wherein the slave device may have only one communication cycle in a given point of time.

That is, the slave device may not be controlled by any master device while the communication cycle is performed in one slave device, however a plurality of communication cycles may be performed for a plurality of slave devices in the master device in a given point of time, the plurality of communication cycles comprising 4 types such as {1-Request, 1-Response}, {1-Request, Multi-Response), {1-Notification}, (Repeated-Notification}.

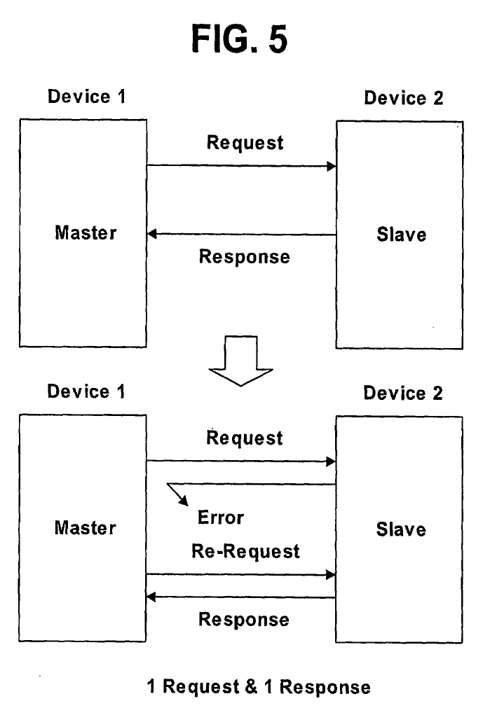

For example, the communication cycle {1-Request, 1-Response} is a communication cycle in which one master sends one request packet to one slave, and the slave sends back one response packet to the master in return, and if an error occurs in the received packet, the master sends re-request packet to the slave, the slave sends back response packet in return, as shown in FIG. 5.

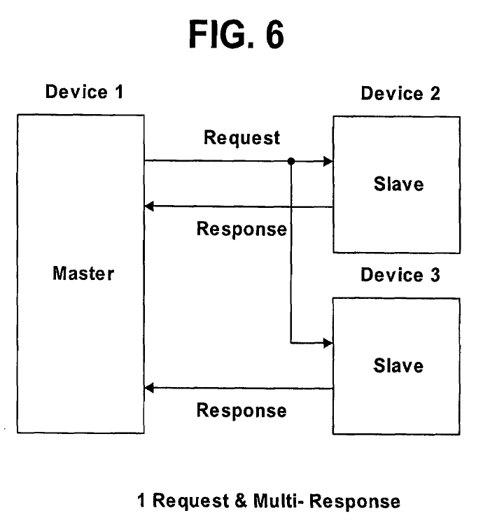

In addition, in the communication cycle {1-Request, Multi-Response}, one master sends one request packet having a group address to a plurality of slaves, and then each slave sends back response packet to master in return, as shown in FIG. 6. The master ends the cycle if an allowed maximum receiving time lapses. At this time, although an error occurs in the response packet received from the slave, the master ignores the error.

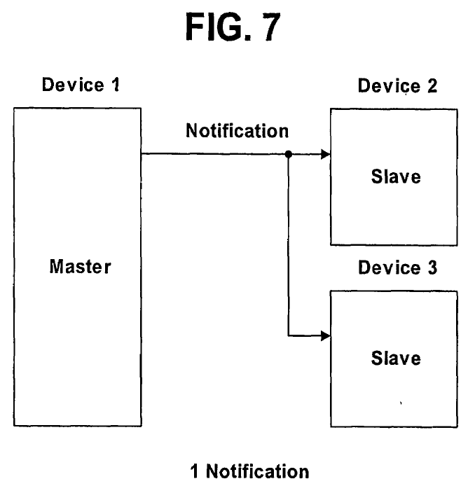

And, the communication cycle {1-Notification} is a communication cycle in which the master device sends one notification packet to one device or a plurality of devices and then immediately ends the communication as shown in FIG. 7, and the communication cycle {Repeated-Notification} is a communication cycle in which the master device repeatedly sends the same packet and then ends the communication for securing the reliability of transmission in the communication cycle {1-Notification}.

Meanwhile, the LnCP network supports a flexible address management. For example, the appliances having LnCP function are assigned addresses on the basis of type of the appliance when shipped from factory, and thus may configure a network without user's participation automatically. At this time the network manager has an algorithm which assigns an unique address to the appliance, when the appliance is connected thereto, since the same kind of appliances are initialized with the same addresses.

In addition, the LnCP network allows performing group communication using one message by assigning unique group addresses to the appliances included in the same kind, classifying various types of appliances into cluster according to the user's needs, and assigning the group address to each cluster.

And, the LnCP network supports variable-length of packet communication, which, for example, adjusts the length of packet using the size information of buffer in the appliances exchanged with each other, in case of downloading contents such as application program related to the control of appliances, or uploading the data stored in the appliances.

In addition, the LnCP network provides a standard message set. For example, the application layer defines a standard message set apt for various types of appliances, so that the master device may control the other appliances, wherein the message set is divided into a common area message set for basic LnCP communication, an application area message set for support of unique function of the appliances, and a developer area message set for providing an unique function of manufacturer.

Meanwhile, the message set may be extended if needed, and factors may also be added to the existing defined message. Hereafter, a flexible address management method, which is one of principle properties of the LnCP network according to the present invention, will be described below in more detail.

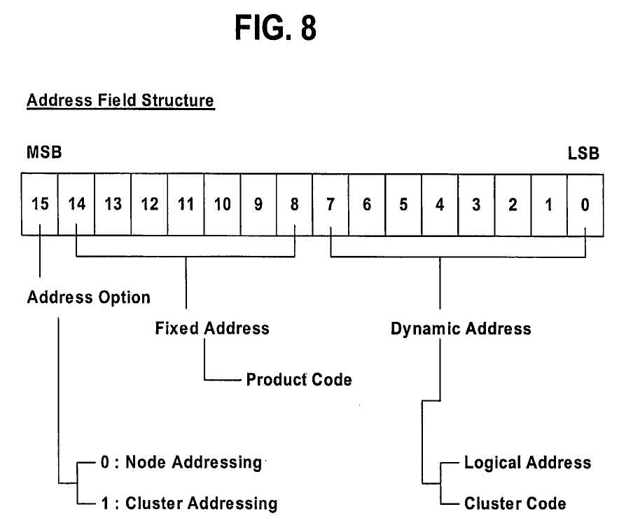

FIG. 8 is a block diagram of illustrating an embodiment of address field structure according to the present invention. The master and slave connected to the LnCP network should have a node address. The present invention has an unique address field structure to perform the address management more flexibly, which includes 1 bit of address option, 7 bits of fixed addresses, and 8 bits of dynamic addresses, as shown in FIG. 8.

Meanwhile, the LnCP network utilizes the 1 bit of address option to use the cluster address which can integrally control grouped specific group of appliances according to the installation place of the appliances such as living room, room, bathroom, etc. or user's needs. For example, if the address option value is ‘0’, it represents node address, and if the address option value is ‘1’, it represents cluster address.

In addition, the LnCP network utilizes the 7 bits of product codes to assign group address according to the product kind. For example, monofunctional product codes are assigned to multifunctional products, respectively.

And, the LnCP network utilizes 8 bits of logical addresses to classify a plurality of appliances on the basis of product of each appliance, wherein the cluster code of appliance shares the field with the logical address as shown in FIG. 8, and the user inputs the cluster code using the appliance performing the function of network manager when the user registers the appliances connected to the network.

Meanwhile, the product code of the appliance, which is a fixed address fixed according to each product kind, is set up in advance when the appliance is shipped from factory and the same kind of appliance should be assigned the same fixed address. Accordingly, according to the product kind, the appliances are classified respectively, and although the device is not assigned a logical address in the LnCP network, the product may communicate over the network immediately when shipped from factory, thus making it possible to implement plug and play in the LnCP network configuration.

In addition, the product codes are assigned by ones for generally applied independent functions of the product and multifunctional products may be assigned a plurality of product codes. For example, refrigerator, which is defined as the product with a cold storage function and a freezing function, is assigned one product code, and the multifunctional product of TV and VCR is assigned two product codes corresponding to TV and VCR, respectively.

And, the product code assigned 7 bits of fixed addresses may designate 126 types of appliance addresses ranging from 0x00 to 0xFD, and 0x7E refers to the product not assigned product code, and 0x7F refers to all the products.

Meanwhile, the dynamic address, which is used to classify a plurality of appliances for the same product, or classify the cluster, may be changed by the network manager and include two meanings as follows depending on the address option value.

For example, if the address option value is ‘0’, the LnCP device may be designated. At this time the dynamic addresses become logical addresses to classify a plurality of the same kinds of products (the product having the same product code). If the address option value is ‘1’, the cluster composed of LnCP devices may be designated. At this time, the dynamic addresses become cluster addresses. In case the illuminating device exists in plurality in the LnCP network, each illuminating device is classified by the same product code and separate logical address.

In addition, the group included in each illuminating device may be classified by the same cluster code, wherein the dynamic address value used in the LnCP network, which is ranging from 0x01 to 0x7E, may designate 127 products or clusters, and 0x80˜0xFE of the remaining values is reserved for the management layer in the LnCP network, 0x00 designates the appliances not assigned the dynamic address, and 0xFF designates all the devices assigned the same product code.

And, the group address may be classified into an explicit group address and an implicit group address. The explicit group address designates all devices included in the same cluster in case the address option value is set up as ‘1’, and the implicit group address may designate a plurality of devices by filling up all the bit values of the fixed address or dynamic address field with ‘1’.

That is, if the bit of product code field is all 1(0xFF), then it means all the devices with specific product code field values.

Meanwhile, when the product code is 0b0XXX XXXX, the logical address is 0bYYYY YYYY, and the cluster code is 0bZZZZ ZZZZ, the kind of device group is as follows. For example, all devices are 0b1111 1111 1111 1111 or 0b0111 1111 1111 1111(0xFFFF or 0x7FFF) and all the devices with specific product codes are 0b1XXX XXXX 1111 1111 or 0b0XXX XXXX 1111 1111.

In addition, all the devices included in the specific cluster are 0b1111 1111 ZZZZ ZZZZ, all the devices with the specific product codes included in the specific cluster are 0b1XXX XXXX ZZZZ ZZZZ, all the devices with the specific logical address are 0b0111 1111 YYYY YYYY.

And, as the other addresses, for example, the network manager has 0x00 product code and 0XXX logical address, and some network managers among the network managers, which have a home gateway function of providing the connection to the external network such as Internet, may utilize fixed 0x00 product code and fixed 0x000 logical address. And the network manager may be implemented within one monofunctional product, as an example of which TV may have both codes, one of which is a product code for TV function and the other is a product code for management function of the network manager.

On the other hand, a master such as the network manager and the like, and a slave such as the TV and the like transmit and receive messages using addresses assigned flexibly as described above.

The address management method and message transmitting and receiving method in the network control system according to the present invention which is configured and operated as mentioned above, may provide the convenience of remote control and monitoring to the user, and also control bias appliances in the network control system more efficiently.

As describe above, while the present invention has been disclosed for the purpose of illustration with reference to the aforementioned preferred embodiment, the living network may be called by other names, and more various appliances can be connected to a living network according to the present invention, and it will be understood by those skilled in the art that the foregoing embodiment can be improved, modified, substituted or added in a variety of ways without departing from the technical spirit and scope of the invention as defined by the appended claims.

1. An address management method in a network control system assigning one address to a master and a slave in the network control system, wherein the address field structure comprises,
an address option for classfying node address or cluster address,
a fixed address fixed according to product kind; and
a dynamic address for classifying a plurality of the same products, or classifying the cluster.

2. The address management method according to claim 1, wherein the address option has 1 bit of value, if the value is ‘0’, it represents a node address, and if the value is ‘1’, it represents a cluster address.

3. The address management method according to claim 1, wherein the fixed address has 7 bits of values and a product code fixed according to the product kind is used.

4. The address management method according to claim 3, wherein the product codes are assigned by ones for generally applied independent functions of the product.

5. The address management method according to claim 3, wherein a multifunctional product is assigned a plurality of product codes.

6. The address management method according to claim 3, wherein the product code has 7 bits of values, which designate 126 types of fixed addresses for the appliances in the range from 0x00 to 0xFD, 0x7E of the remaining values designates fixed addresses for the appliances which the product code is not assigned, and 0x7F designates all the appliances.

7. The address management method according to claim 1, wherein the dynamic address has 8 bits of values, which are set up or changed by a network manager.

8. The address management method according to claim 7, wherein the dynamic address designates logical address or cluster code according to the address option value.

9. The address management method according to claim 8, wherein, if the address option value is ‘0’, the dynamic address is designated as logical address for classifying a plurality of the same kind of products.

10. The address management method according to claim 8, wherein, if the address option value is ‘1’, the dynamic address is designated as cluster code for a plurality of grouped appliances.

11. The address management method according to claim 1, wherein the dynamic address has 8 bits of values, which designate 127 products or clusters in the range from 0x01 to 0x7E, 0x08˜0xFE of the remaining values are reserved for a network management layer, 0x00 designates the appliances which the dynamic address is not assigned, and 0xFF designates all the devices assigned the same product code.

12. The address management method according to claim 1, wherein designating all the devices included in the same cluster with the address option value set up as ‘1’ is managed by an explicit group address, and

13. The address management method according to claim 1, wherein setting up all the bit values of the fixed address or dynamic address as ‘1’ is managed by an implicit group address.

14. The address management method according to claim 13, wherein among the implicit group address, if the fixed address values are all ‘1’, all kinds of products are designated with a group, and

15. The address management method according to claim 13, wherein if the dynamic address values are all ‘1’, all the product with specific products code are designated with a group.

16. A message transmitting and receiving method in a network control system comprising the steps of:
assigning an address comprising an address option for classfying node address or cluster address, a fixed address fixed according to product kind, and a dynamic address for classifying a plurality of appliances for the same product, or classifying the cluster; and
performing message transmitting and receiving operation between the master and slave, based on the assigned address.

17. The message transmitting and receiving method according to claim 16, wherein the address option has 1 bit of value, if the value is ‘0’, it represents a node address, and if the value is ‘1’, it represents a cluster address.

18. The message transmitting and receiving method according to claim 16, wherein the fixed address has 7 bits of values and a product code fixed according to the product kind is used.

19. The message transmitting and receiving method according to claim 1, wherein the dynamic address has 8 bits of values, which are set up or changed by a network manager.

20. The message transmitting and receiving method according to claim 7, wherein the dynamic address designates logical address or cluster code according to the address option value.
